(19) United States
(12) Patent Application Publication
(10) Pub. No.: US 2020/0339461 A1
(43) Pub. Date: Oct. 29, 2020

(54) PRODECURE FOR IMPROVING DEWATERABILITY OF BIOSOLIDS CAKE AND PRODUCTION OF HIGHLY DEWATERED BIOSOLIDS CAKE

(71) Applicant: Lystek International Corp., Cambridge (CA)

(72) Inventor: Owen Patrick Ward, Waterloo (CA)

(73) Assignee: Lystek International Corp., Cambridge, ON (CA)

(21) Appl. No.: 16/633,676

(22) PCT Filed: Jul. 25, 2018
(86) PCT No.: PCT/CA2018/050902

§ 371 Date: Jan. 24, 2020

(30) Foreign Application Priority Data
Jul. 25, 2017 (GB) 1711996.7

(51) Int. Cl. C02F 11/145; C02F 11/13; C05F 7/00; C05G 5/14; C05G 5/23

(52) U.S. Cl. CPC C02F 11/145; C02F 11/13; C05G 5/23; C05G 5/14; C05F 7/005

(57) ABSTRACT

A biosolids cake treatment process comprising mixing a biosolids cake having more than 10% solids with an alkali to bring the mixture's pH to 11 or higher, heating the mixture to 80° C. or more and dewatering the heated mixture. The dewatered product can be used as a fertilizer and the separated liquid fraction can be fed back to digesters. The alkali can be one or more of or a mixture of calcium oxide (CaO), calcium hydroxide (CaOH), and lime.

### FIELD OF THE INVENTION

The invention relates to the further processing of biosolids cake in waste-water processing systems.

### BACKGROUND

Recovery, processing, off-site transport and reuse/disposal of biosolids is one of the most expensive costs of waste-water treatment processes. Consequently, there is great interest in developing processes which reduce these costs.

A widely used practice is to de-water the biosolids material, using filters, centrifuges and/or presses, so as to produce a biosolids cake typically having a solids content of 18-24%. In this, only rarely and at high expense is a cake with a solids content of 25% or higher produced. This cake form material, as a solid, may be stored, transported and used as a fertilizer, incinerated or landfilled. This biosolids cake may be converted to a pumpable liquid, having a solids content of 10% or higher, which reduces pathogens, and facilitates handling, transport and land application by injection.

There is a great need for methods which reduce the volume of biosolids cake requiring transport off-site for re-use or disposal.

It is well known that the organic make-up of biosolids, whether liquid, solid, in between, a mixture, all or both, renders the material difficult to de-water. Chemical polymers are widely used to promote flocculation of bacterial cells and other particulates, which make up digester biosolids effluents. Flocculation facilitates settling, dewatering and concentration of effluent solids in the process from about 1-3% (raw waste) up to about 18-24% solids in typical biosolids cake. Chemical polymer usage often represents an expensive component of biosolids handling from raw waste to cake form. The EPA's fact sheet on centrifuge thickening and dewatering indicates that polymer costs for biosolids residuals dewatering can be as much as $80 per dry ton solids.

Biosolids digester effluents are generally difficult to de-water due to the presence of colloidal materials and extra-cellular polymeric substances. These have the capacity to bind and capture large numbers of water molecules, thus making dewatering challenging. These effluents also have a variable amount of these components. The variability itself results in variable de-watering characteristics, and, consequently, variable amounts and costs of the chemical polymers required to achieve a specific dewatered cake solids content and the processing facilities required for high volume production.

Further variability in biosolids content results from common external processing factors, including mechanical forces and chemicals, which can affect de-waterability by interfering with flocculation processes. Mechanical forces reduce the strengths of, or sizes of, flocs and cause deterioration of biosolids de-waterability.

The chemicals used for flocculating cells and other biosolids components often are multi-positively charged polymers, which bind to the negative charges on cells and other biosolids particulates, thereby bridging these particulates as part of the flocculating and dewatering process.

Positively charged ions, such as sodium, potassium, calcium or magnesium, can also bind to these negatively charged particulates, thereby reducing interaction between flocculating polymers, cells and particulates. Therefore, addition of alkalis to digesters, including alkalis in the form of hydroxides of sodium, potassium, calcium or magnesium, can have the effect of reducing dewaterability and/or increasing the amounts of the very polymers required for dewatering.

While each sodium or potassium atom has one positive charge (ie monovalent) to react with particulates, each calcium or magnesium atom has two positive charges (ie divalent) and can neutralize two negative charges of the particulates. The less costly calcium or magnesium form has a more deleterious effect on the polymer's desired particle flocculating function. The effects of divalent ions, such as calcium or magnesium, are more complex because they can potentially also use their two charges to interact with the negative charges on two cells or particles, thereby bridging them and promoting flocculation. This conflict introduces even more variability in the process.

Mechanical treatment can result in cell disintegration and cause a reduction in the particle sizes of solid particles, and an increased number of those particles. This can also cause a negative effect on de-waterability. Disintegration releases negatively charged polysaccharides and other biopolymers, which are poorly degraded during digestion and increase flocculating polymer demand for dewatering.

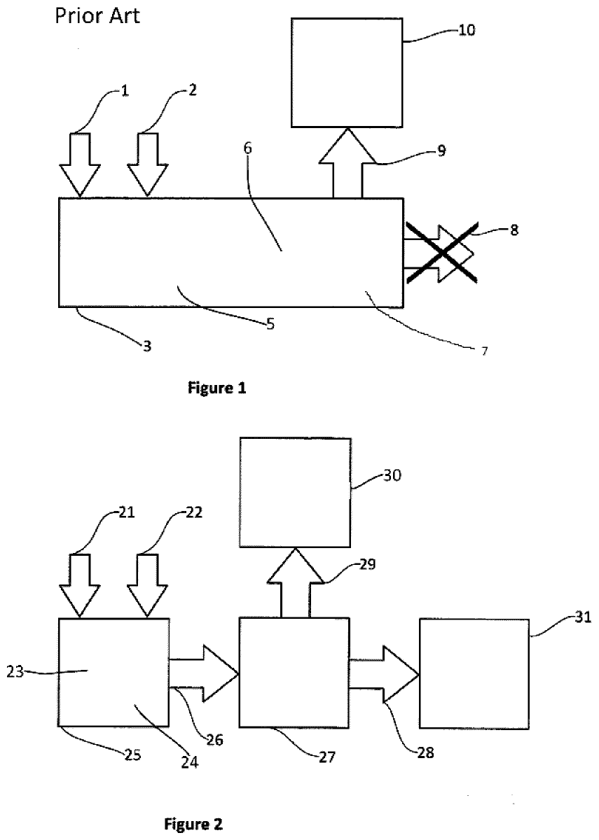

Colloidal materials and extra-cellular polymeric substances tend to increase viscosity of biosolids. Mechanical treatments, including shearing, have a negative effect on de-watering, even though shearing can also reduce the viscosity of biosolids. The relationship between biomaterials viscosity reduction and de-watering is complex. For clarity, FIG. 1 sets out an example discussed in U.S. Pat. No. 6,808,636 where 18% biosolids cake (BSC) 1 is mixed with alkali 2 in a mixer 3 for thorough combining and cooking, as at 5, for defined times and temperatures and the material 6 is severely sheared as at 7 in a single process. At that point what is optimally produced is a pumpable liquid 9 containing more than 18% solids which itself can be readily transported and used as a liquid fertilizer, as at 10. Experiments have shown that this liquid 9 is not readily dewatered further despite its liquid characteristics as at 8 without use of polymer at costs similar to those referenced by EPA above.

In addition, if the processed material fed back to digesters has been treated in a manner which has a negative effect on its dewaterability (for example through greater release from cells of colloidal materials or extracellular polymeric substances or through cell particle size reductions/increased numbers of particles), the non-degraded portion of these materials which emerges in the digester effluent will have a negative effect on dewaterability. This in turn will cause an increase in chemical polymer demand for dewatering in the digester. A disadvantage of strategies which rely predominantly on feeding pre-treated unseparated biosolids back to digesters to reduce overall volumes of biosolids produced is that it takes a substantial period of time and much effort to demonstrate the effectiveness of any approach to potential users of the technology (typically 3-6 months or longer to set up, run, sample and analyses a pilot digestion process simulating the large scale digesters in the plant of the potential user). Even so, the effectiveness of feeding the pre-treated biosolids back will vary with varying compositions of the biosolids produced in a particular plant and with varying digestion conditions and parameters.

In addition to being a rich source of fertilizer nitrogen and potassium, biosolids is also a rich source of phosphorus. In certain cases, where organic materials are used as fertilizers, including animal manures and biosolids, soils may be over-enriched with phosphorus, undesirably increasing phosphorus levels in run-off water and ultimately in rivers and lakes. Hence, some biological wastewater treatment processes are being designed to promote biological phosphate removal, processes which may require digester augmentation with other substrates and co-digestion feeds such as glycerol.

### Definitions

Biosolids in this application is organic matter recycled from sewage, especially for us in agriculture.

Biosolids Cake in this application is a solid pre- or post-digested de-watered sewage sludge.

Solid in this application refers to a body of material which is not seen to slump under the influence of gravity at ambient temperatures.

Testing in this application includes both testing per se and use of a previously tested or verified result.

Solids Content in this application includes biosolids and other solids taken together.

Shearing in this application is mechanical shearing substantially beyond the mere mixing together of ingredients to the point where biological solids components of the biosolids cake are broken down mechanically, such as by disrupting the structure of cellular components.

### OBJECTS OF THE INVENTION

One objective in reducing volumes of biosolids cake is to alter the properties of the biosolids to improve the dewatering processes, such that the solids content of the cake is substantially increased above the typical 18-24% values.

Another objective is to develop a combination process, involving:
(a) enhanced pre-treatment and dewatering of biosolids, to reduce cake volumes for off-site transport, and,
(b) feeding back the supernatant or liquid fraction to digesters for breakdown of some of the biosolids components present in the separated liquid phase.

Another objective is to develop means of reducing biosolids volumes for re-use or disposal without increasing (or substantially increasing) polymer costs.

In a still further object of the invention to avoid the lower viscosities provided by combined thermochemical and shearing methods.

Another object is to reduce costs and also to reduce undesirable phosphorus content digester fee back using calcium which causes phosphate to form an insoluble precipitate of calcium phosphate and heating further accelerates and promotes this precipitation. The objective is to reduce the phosphorus content by greater than 90%.

### THE INVENTION

The invention provides a process producing highly dewatered biosolids cake (HDBC) involving biosolids cake pre-treatment followed by dewatering.

In one aspect of the invention produces a dewatered biosolids cake product having a solids content of 30%, 35%, or more, and a supernatant or liquid fraction.

In another aspect of the invention the combination of the pre-treatment and dewatering processes of the invention with feeding back the supernatant/aqueous fraction to digesters greatly reduces the overall volume of biosolids requiring off-site transport for reuse or disposal.

Another aspect of the invention provides reduction of the overall volume of biosolids requiring off site disposal by 30% or more and 40-50% or more.

A further aspect of the invention combines pre-treatment parameters which have a minimal negative on the effectiveness of flocculating polymers and/or which may be carried out without polymer use at all or minimized.

In another aspect of the invention avoids mechanical pretreatments which reduce biosolids particles size, increase the number of particles and have an adverse effect on dewatering.

Yet a further aspect of the invention is to use alkali as the pre-treatment chemical and especially calcium oxide or calcium hydroxide.

Therefore, a further aspect of the invention is to reduce the overall amount of pre-treated biosolids being fed back to digesters.

It is still another object of the invention to provide a biosolids cake (BSC) or sludge which is pre-treated and separated, such that the separated supernatant or liquid fraction is more biodegradable, and that fraction is fed back to the digester to augment the digestion process. The non-degraded portion of these materials which emerges in the digester effluent will have less of a negative or have a negligible effect on de-waterability than would be the case if the pre-treated unseparated material is fed back. This in turn will cause a smaller increase in chemical polymer demand for dewatering.

And in another aspect the invention provides a process where pre-treating biosolids sludge (BSC) followed by centrifugation or other separation means, produces a supernatant or liquid fraction (ie the more soluble fraction), in which the organic fraction as a percentage of total supernatant dry weight is enriched, and provide a more biodegradable and more utilizable digester feed, with minimal extra particulate matter. Hence, the feedback process, using this organically enriched supernatant feed, will have a minimal or negligible affect on dewaterability and on polymer demand.

A further aspect of the invention is to pretreat and dewater biosolids cake in a manner in which the supernatant or separated liquid fraction is enriched with organic components, which are generally more biodegradable, and in which the separated solids fraction is enriched with non-degradable (inorganics) and other less degradable materials (insoluble organics).

A still further aspect of the invention provides a significant advantage by using a hybrid process where the predominant volume reduction step is centrifugation, or another solids-liquid separation step, of the biosolids which have been pre-treated in a manner which substantially increases de-waterability. This pre-treatment and dewatering can be demonstrated to potential users in a couple of days. The supernatant or separated liquid fraction represents a small fraction of the overall solids content (about 3-10%) and does not inhibit the digesters.

Hence, a further aspect of the invention is the provision of a hybrid treatment, including dewatering, with supernatant fed back to a digester for processing, where the dominant step in reducing biosolids volume is pre-treatment and dewatering of BSC (Biosolids Cake) which is much more easily demonstrated to prospective users than processes which predominantly rely on pretreatment and digestion, which require prolonged and costly pilot demonstrations.

The invention also provides a biosolids cake pre-treatment, which includes the step of adding a substantial amount of alkali, specifically, calcium oxide or calcium hydroxide, as well as including a heating step, to promote precipitation of any phosphates as insoluble calcium phosphate. When biosolids cake (BSC), pretreated in this manner are dewatered, by centrifugation or another solids-liquid separation step, the insoluble calcium phosphate is be separated with the solids or cake fraction (HDBC) and the process results in production of a supernatant or liquid fraction having a low phosphorus content.

A further aspect of the invention is the promotion of precipitation of phosphates with divalent cations, such as calcium, during the biosolids pretreatment step and to separate those precipitated phosphates with the centrifuged or otherwise separated solids fraction.

A yet further aspect of the invention is to prepare a supernatant or separated liquid fraction, enriched with organic components but which is depleted in phosphorus and to feed back that liquid fraction to digesters depleted in phosphorus to prepare a co-substrate for bio-dephosphorylation processes.

A further aspect of the invention is to further reduce the volume of the highly dewatered biosolids cake (HDBC) fraction using a drying process and to produce a fertilizer component with or without the additional drying.

### FURTHER STATEMENT OF INVENTION

A process for improving the de-waterability of solid biosolids cake having an initial biosolids content of greater than 10%, 15% or 18% comprising placing a quantity of the biosolids cake in a reactor, raising and holding the pH of the biosolids cake to 11 or higher by the intermixing of the biosolids cake with an alkali, and raising and holding the temperature of the biosolids cake to 80 degrees Celsius for a time period, or higher, and testing the biosolids cake, so treated, in a de-watering device wherein a liquid fraction is separated from a solids-containing fraction, and wherein the biosolids cake is treated by the combination of high temperature and alkali for a period of time sufficient for the solids-containing fraction, preferably a solid, to have a biosolids content greater than the initial biosolids content.

The invention also provides a process for separating biosolids cake having an initial biosolids content of greater than 10%, 15% or 18% into a liquid fraction and a highly de-watered solids-containing fraction wherein said testing includes sending the biosolids cake, so treated, to a de-watering device wherein a liquid fraction is separated from a solids-containing fraction.

The invention also provides a process further including preparing the liquid fraction to be fed and feeding it back into digesters (or anaerobic) digesters without the solids-containing fraction and/or drying the solids-containing fraction for use as a fertilizer.

The invention also provides a process excluding mechanical shearing of the biosolids cake prior to said testing or separation of the liquid fraction.

The invention further also provides a process wherein the alkali is one or more of or a mixture of CaO, CaOH, lime in which the amount of alkali added is greater than one of 10 g, 15 g or 20 g as calcium hydroxide [Ca(OH)2] per Kg of 10% biosolids in the biosolids cake or its equivalent and, optionally wherein the alkali is increased proportionately with increased biosolids concentrations of the biosolids cake.

The invention further also provides a process wherein the temperature and time period hold of body of biosolids cake is 80-99.9 degrees Celsius and 6-24 hours, respectively, and optionally above 100 degrees Celsius for shorter periods.

The invention provides a process wherein the solids-containing fraction is transported to a site for use as a fertilizer, re-hydrated to form a liquid and presented as a liquid fertilizer.

### PREFERRED EMBODIMENTS

Twenty to twenty-five percent biosolids cake 21 and Alkali in the form of lime or Ca(OH)2 (preferably Cal85) in a finely divided state to a process reactor 25, being a cooker, wherein the input materials are mixed but not violently sheared 23 and heated 24. Upon or during the completion of the heating cycle mixed and cooked product is moved as at 26 to a separator 27 preferably in the form of a centrifuge. Centrifugation separates a solid-containing cake 28, preferably at about 40% total solids from a liquid fraction 29. Liquid fraction 29 may be fed back into a digester 30 for further processing.

Solids-containing cake 28 may be further processed 31 as by drying, or transported to a site for re-hydration into a pumpable liquid, fertilizer.

### EXAMPLES

Settling by Gravity Over Time

Reduced ability of solids to settle by gravity {settleability} is sometimes used as an indicator of poorer dewaterability. In preliminary tests, studies were carried out on the effects of heat, alkali, calcium ions and shearing on settleability of biosolids using % settleability of 2% biosolids in a cylinder after 21 h. Settleability was expressed as height of the supernatant fraction as % of total liquid material height. In the result shearing had the most negative effect on solids settling (Table 1).

Where solids typically settled to a compact 25-40% of the cylinder (settleability 60-75%), after shearing the solids settled only to 52-89% of the cylinder contents (settleability 11-48%). While shearing had the most negative impact on settleability, increasing the hold temperature also had a negative effect on settleability but to a lesser extent than shearing. Alkali treatments had a slight negative effect on settleability. Addition of CaCL₂ had a negligible effect on settleability.

CST and Dewaterabilitiy

Capillary suction time (CST) values are widely used to predict dewaterabilities of biosolids liquids, that is, the lower CST value indicates better dewaterability.

Thermal Incubation

A separate batch of biosolids cake was diluted with tap water to 6%, incubated for 90 min at the temperatures indicated. The thermally treated biosolids samples were diluted to 3% solids and divided into two samples, one of which was sheared for 3 min in a Ninja single serve homogenizer. Dewaterability properties of the unsheared and sheared samples were measured as Capillary Suction Time (CST) values in seconds (Table 2). The samples were stored refrigerated for further testing.

Dewaterability Deteriorates with Thermal Treatment and with Shearing

The results confirm the observations in Table 1: Dewaterability gradually deteriorates with increase in thermal treatment while shearing has a major negative impact on dewaterability, almost doubling the CST time.

All further CST dewaterability tests were determined at a solids concentration of 3% (the test concentration typically used in literature reports).

Dewaterability Improves with Digestion.

The above thermally treated samples from Table 2 (+/− homogenization or shearing) were digested for 15 days at 37 C and again tested for dewaterability (Table 3). The general pattern shows that digestion improves dewaterability. However, the trends after digestion were the same as with pre-digested samples, ie deteriorating dewaterability due to homogenization/shearing and with increase in pre-treatment temperature.

More Severe Pre-Treatment/Low Alkali/No shearing

A more severe pre-treatment, holding 3% biosolids for 21 h at 80 C and 90 C with and without a low level of alkali addition (no shearing homogenization) also demonstrated similar patterns (Table 4). Dewaterabilities after pre-treatment and after digestion were extremely poor.

55 C Pre-Treatment

A 20 h pre-treatment of 8% biosolids was carried out at temperatures in the range 70-55 C, 20 h (+ an untreated control) and observed some excellent pre- and post-digestion dewatering results were observed for the 55 C pre-treatment (Table 5).

The Thermo-Chemical Pre-Treatment Invention

Increased Hydroxide Plus Prolonged Thermal Treatment

When biosolids was treated with increasing levels of Ca(OH)₂ (all greater than 3.3 g/Kg 10% biosolids tested in Table 4) and held for 1.5, 6 and 24 h at 55 C the more prolonged holds at higher alkali treatments led to dramatic improvements in dewaterability (Table 6).

Whereas untreated 3% biosolids exhibited a CST dewatering value (higher is poorer) of 340, and higher values are observed after thermal treatment alone, post digestion values of ˜100, and especially ˜50, reflect outstanding dewaterabilities. The properties of biosolids with CST values of ˜200-1000 are more gel like on a subsequent filter whereas the solids in products with values of 100 and 50 are more particulate/grainy on the CST filter pad and the water just runs away.

Further Increased Hydroxide Treatment Plus Prolonged and Elevated Temperature Holds.

Similar tests were carried out with increasing Ca(OH)₂ treatments and thermal holds of 5 h and 22 h at 90 C and 75 C (Table 7). Post-digestion CST values after 22 h holds at 75 C and 90 C after a 9 day digestion (˜100 and even 40, 50) show 100 greatly improved dewaterability. Within each sub-group (1-4, 5-8, etc.) pre-digestion dewaterabilities (CSTs) show a pattern of improved dewatering in conjunction with the increase in concentration of Ca(OH)₂ in the Ca(OH)₂ range of 10-15 g per Kg 10% biosolids.

When biosolids cake was treated with increasing concentrations of Ca(OH)₂ in the range 12.5-20 g/Kg 10% biosolids and held at 90 C/20 h (Table 8) biosolids dewaterability (no digestion) was shown to improve as a function of increasing Ca(OH)₂ concentration. With these treatments, viscosities of the product (starting with 10% biosolids) reduced as a function of increasing Ca(OH)₂ concentration. A single homogenization shearing test was carried out on the most dewaterable sample (no 4). Dewaterability was poorer after homogenization.

Dewatering by Centrifuge

Dewatering characteristics of biosolids cake, prepared using selected pre-treatment conditions were also tested using a bench centrifuge (15 min., 6000×g). The tests (Table 9) using previous pre-treatment conditions show that 115 temperature holds of 20% biosolids 75-95 C for 22 h with 30-40 g Ca(OH)2/Kg biosolids produced good dewatering with resulting pellet (solid fraction) solids contents of 25-26%. Lower alkali dose rates and inclusion of a homogenization step resulted in poor or no centrifugal separation, that is, very poor dewaterability. Best dewaterabilities were observed in samples where pre-treatments of 20% biosolids produced liquids with viscosity of <4000 cps and preferably less than 2000 cps. Combining homogenization (carried out after thermal) with this thermal alkaline treatment further reduced viscosities of 20% biosolids pre-treatment 95 C, 22 h, from 1770 cps to 714 cps at a dose rate of 40 g Ca(OH)2 per Kg 20% biosolids but those lead to a deterioration in biosolids dewatering properties. (714 cps is similar to viscosity treatment at 160 C for 60 min of 20-23% cake; and would correspond to 400-500 cps at 15% biosolids).

Thermal Pre-Treatment of 24% Biosolids Cake—Thermal Hydrolysis Plus Alkali

The thermal pre-treatment was also carried out on 24% biosolids at the typical high temperature for thermal hydrolysis (160 C) for 60 minutes, with and without alkali. Following the pre-treatment, samples were cooled and centrifuged at 6000 g, 15 min. The results are presented in Table 10. No separation occurred in the no alkali, 160 C thermal treatment whereas a clear separation was observed in the thermal alkali treated sample and solids content in the solid fraction pellet was 38%.

Thermal Pre-Treatment Plus Hot 95 C Centrifugation

Improved dewatering was observed when the 95 C/22 h (40 g Ca(OH)₂/Kg 20% BS) treated material was preheated to 95 C prior to centrifugation. In the experiment in Table 11, it is shown that centrifuging hot material increased the solids content of the solids fraction pellet (cake) to 34.3%. It should be noted that the hot material quickly cools down during this bench batch centrifugation. Even better dewatering than this is expected to be achieved through better maintenance of hot material temperature during centrifugation.

The negative effects of homogenization and the positive effects of centrifuging pre-heated material were confirmed in the tests summarized in Table 12 where solids content in the solids fraction pellet from hot pre-treated product was 36.5%.

Thermal Pre-Treatment at 121 C Plus Hot Centrifugation

The thermal pretreatment was also carried out on 24% biosolids at typical autoclaving temperatures, 121 C for 75 min., with and without alkali. Following the pre-treatment samples were cooled to about 90 C and centrifuged hot at 6000 g, 15 min. The results are presented in Table 13. Again, no separation occurred in the no alkali, thermal treatment whereas a clear separation was observed in the thermal alkali treated sample and the solids content in the solids fraction pellet was 37%.

Moist Surface Upon Separation

In these bench scale batch centrifugations when the supernatant is poured from the centrifuge tube it is noted that the pellet surface remains quite moist. In Table 14, following pouring off the supernatant the tube was cut to divide the solids fraction pellet into two portions, the top half and bottom half. The solids contents of the total solid fraction pellet, top half of pellet and bottom half of pellet were 37.7%, 28.8% (Lower solids concentration top half) and 45.3% (higher-solids-concentration-bottom-half), respectively. The solids content in the supernatant was 7.5%. Volatile (organic) solids content in the supernatant was 76.7% and 44.6% in the pellet. In the top and bottom half of the pellet volatile solids contents were 54.5% and 39.2%, respectively. In other tests centrifuged pellets having solids contents of >40% have been prepared.

Results

The results indicate the above biosolids cake ThermoChemical Pretreatment produces a dewatered cake having ˜40% solids in the solids fraction. The combined effect of dewatering to ˜40% solids and feeding back the organically rich supernatant (liquid fraction) to digesters allows for a reduction of 50% or more in biosolids requiring off site disposal.

Centrifugation conditions can be manipulated to capture as cake the higher-solids-concentration-bottom-half solids fraction described above providing further reductions in biosolids needing to go off site.

Feeding back dewatered biosolids (untreated or treated) for co-digestion is counterproductive as it will have the effect of increasing the solids load in the digester.

In contrast, feeding pure organic carbon sources such as glycerol to digesters for co-digestion provides no change in dewaterability. The feedback of a rich organic supernatant rather than pretreated unseparated liquid biosolids is beneficial in minimizing any increase in solids loading and the flocculent (polymer) use.

TABLE 1
Effect of Biosolids Pre-treatment on Settleability

| | | % Settleability after | | |
|---|---|---|---|---|
| | | | | 3. Heat treatment + |
| | | 1. Heat treatment | 2. Heat treatment + | addition of |
| Ca(OH)₂ | Holdi Temperature | (pH after | addition of | CaCL2 + |
| g/L per 10% BS | (90 min) | treatment) | CaCL2 | shearing |
| 0 | Room | 75.8 (8.0) | 73.8 | 53.7 |
| 3.3 | | 73.8 (8.3) | 73.8 | 52.4 |
| 10 | | 73.8 (9.2) | 73.8 | 547.5 |
| 0 | 60° C. | 76.9 (8.0) | 78.6 | 53.8 |
| 3.3 | | 75.0 (8.3) | 76.8 | |
| 6.6 | | 71.7 (8.7) | 71.8 | |
| 10 | | 69.7 (9.0) | 71.4 | 50.0 |
| 0 | 70° C. | 71.0 (8.0) | 72.5 | 51.0 |
| 3.3 | | 70.3 (8.3) | 70.7 | |
| 606 | | 67.2 (8.7) | 69.3 | |
| 10 | | 68.8 (9.2) | 68.8 | 51.3 |
| 0 | 80° C. | 69.7 (8.0) | 71.4 | 47.6 |
| 303 | | 64.1 (8.4) | 65.0 | |
| 606 | | 65.6 (8.7) | 67.5 | |
| 10 | | 64.0 (9.2) | 67.9 | 47.6 |
| 0 | 90° C. | 59.0 (8.2 | 64.2 | 11.0 |
| 3.3 | | 59.4 (8.4) | 61 | |
| 10 | | 67.0 (9.4) | 66 | 29.5 |

*% Settleability after 21 h = (height of supernatant/total height of liquid) × 100 Different amounts of calcium hydroxide were mixed into biosolids (2% w/w). Each mixture was incubated at room temperature, 60° C., 70° C., 80° C., 90° C. for 90 minutes. Each treated mixture was cooled to room temperature and added to cylinders [4.4 cm (internal diameter) × 25 cm (height)]. The cylinders were held at room temperature for 21 h to allow solids to settle out. Calcium chloride was then added to each cylinder at a rate equivalent to 2% of dry biosolids content. The contents of each cylinder was remixed and allowed stand again at room temperature for 21 h after which settleability was again measured. Finally the contents of selected cylinders were violently mechanically sheared in a Ninja Homogenizer for 3 minutes. The sheared mixtures were placed back in the cylinders and allowed to stand again at room temperature for 21 h after which settleability was again measured.

TABLE 2
Effects of Biosolids Thermal Pretreatment on CSTs

| Incubation | Dewaterability (CST) | |
|---|---|---|
| Temperature C. | | Homogenisation shear (Ninja |
| (90 min) | No Homogenisation | single serve - 3 min) |
| Room | 343 | 597 |
| 60 | 352 | 690 |
| 70 | 429 | 698 |
| 80 | 488 | 899 |
| 90 | 617 | 1232 |
| | Avg 446 | Avg 823 |

TABLE 3
Effect of pretreatment temp and homogenization on dewaterability
of biosolids(CST)
Thermally treated 6% BS samples from Table 2 were diluted to 3%.
180 g of the diluted samples was placed in an anaerobic digester
together with 40 g of a 3% inoculum and digested at 37 C.

| Hold | *Homo | | | Digestion Time | | | CST after | |
|---|---|---|---|---|---|---|---|---|
| Temp | g 3 Min | CST | | (in days) | | | digestion | |
| 90 min | (Ninja) | (3%) | | T5 | T10 | T15T | T16 | T20 |
| 24 C. | No | 343 | Net gas mL/ | 468 | 632 | 721 | 260 | 227 |
| 24 C. | Yes | 597 | reactor | 416 | 605 | 688 | 387 | 368 |
| 60 C. | No | 352 | | 420 | 675 | 868 | 352 | 240 |
| 60 C. | Yes | 690 | | 396 | 652 | 755 | 475 | 441 |
| 70 C. | No | 429 | | 434 | 701 | 795 | 387 | 355 |
| 70 C. | Yes | 698 | | 414 | 705 | 811 | 527 | 506 |
| 80 C. | No | 488 | | 492 | 769 | 892 | 447 | 399 |
| 80 C. | Yes | 899 | | 473 | 780 | 879 | 486 | 577 |
| 90 C. | No | 617 | | spill | | | | |
| 90 C. | Yes | 1232 | | 474 | 821 | 911 | 915 | 707 |

| | | | |
|---|---|---|---|
| Avg No Shear | 446 | *361 | *305 |
| Avg with Shear | 823 | *469 | *473 |

*excl 90's because of
spill

*violently sheared after thermal hold

TABLE 4
Effect of thermal +/− alkali pretreatment and digestion on CST of
3% BS (Digestion conditions as in Table 3)

| Hold | Ca(OH)2 | | Digestion Time | | | |
|---|---|---|---|---|---|---|
| Temp | g/L per | CST after | (in days) | | | CST after |
| 21 h | 10% BS | pretreatment | T5 | T10 | T14 | digestion |
| 80 | 0 | 780 | 393 | 810 | 875 | 609 |
| 80 | 3.3 | 1052 | 404 | 743 | 814 | 825 |
| 90 | 0 | 1178 | 402 | 804 | | 799 |
| 90 | 0 | 1178 | 401 | 847 | 934 | 644 |
| 90 | 3.3 | 1176 | 400 | 811 | 909 | 762 |
| 90 | 3.3 | 1176 | 402 | 832 | 907 | 529 |

TABLE 5
Effect of temperature pretreatment of 8% BS and digestion on
dewaterability (CST) (Digestion conditions as in Table 3)

| | | | Digestion Time | | | CST after | |
|---|---|---|---|---|---|---|---|
| Hold | CST after | | (in days) | | | digestion | |
| Temp | pretreatment | | T6 | T8 | T12 | T12 | T13 |
| Control | 340 | Net Gas | 314 | 462 | 538 | 119 | 132 |
| 55 | 498 | mL/reactor | 321 | 505 | 613 | 158 | 164 |
| 60 | 431 | | 353 | 558 | 664 | 330 | 391 |
| 65 | 534 | | 377 | 564 | 673 | 214 | 562 |
| 70 | 605 | | 379 | 597 | 690 | 410 | 397 |

TABLE 6
Effect of pretreatment temp +/− alkali of 3% biosolids on
digestion and CST (Digestion conditions as in Table 3)

| | | Ca(OH)2 | | | | | Digestion | | |
|---|---|---|---|---|---|---|---|---|---|
| | Hold | g/L | | | CST | | Time | | CST |
| | Temp/ | per 10% | PH | PH | before | | (in days) | | after |
| | time | BS | initial | final | digestion | | 5 d | 12 d | digestion |
| 1 | 55 C. | 0 | 8.2 | 8.1 | 391 | Net gas | 182 | 476 | 211 |
| 2 | 1.5 h | 5 | 9.4 | 9.1 | 493 | mL/ | 229 | 493 | 52 |
| 3 | | 10 | 10.2 | 9.8 | 597 | reactor | 177 | 438 | 313 |
| 4 | | 15 | 12 | 11 | 335 | | 177 | 480 | 330 |
| 5 | 55 C. | 0 | 8.2 | 8.0 | 402 | | 225 | 463 | 100 |
| 6 | 6 h | 5 | 9.4 | 9.1 | 521 | | 205 | 469 | 225 |
| 7 | | 10 | 10.2 | 9.7 | 592 | | 167 | 439 | 51 |
| 8 | | 15 | 10.5 | 9.1 | 325 | | 203 | 540 | 128 |
| 9 | 55 C. | 0 | 8.2 | 8.0 | 446 | | 294 | 506 | 300 |
| 10 | 24 h | 5 | 9.4 | 8.7 | 508 | | 238 | 479 | 55 |
| 11 | | 10 | 10.2 | 9.3 | 581 | | 177 | 440 | 39 |
| 12 | | 15 | 12 | 10.3 | 335 | | 173 | 515 | 100 |

TABLE 7
Effect of pretreatment temp +/− alkali and digestion on CST of 3% BS
(Digestion 180 g 3%BS, 35 g Inoculum) Untreated CST 3% 348

| | Hold | Ca(OH)2 | | | CST | | Digestion | | CST |
|---|---|---|---|---|---|---|---|---|---|
| | Temp/ | g/L per | PH | PH | before | | Time | | after |
| | time | 10% BS | initial | final | digestion | | 6 | 9 | digestion |
| 1 | 90 C. | 0 | | | 644 | Net Gas | 279 | 421 | 373 |
| 2 | 5 h | 10 | 8.2 | 8.2 | 809 | mL/ | 288 | 437 | 154 |
| 3 | | 12.5 | 10.2 | 9.4 | 379 | reactor | 269 | 416 | 186 |
| 4 | | 15 | 11 | 9.7 | 476 | | 335 | 573 | 214 |
| 5 | 90 C. | 0 | 8.2 | 8.5 | 820 | | 229 | 420 | 94 |
| 6 | 22 h | 10 | 10.2 | 9.1 | 700 | | 329 | 508 | 97 |
| 7 | | 12.5 | 11 | 9.4 | 301 | | 323 | 486 | 86 |
| 8 | | 15 | 12 | 9.9 | 157 | | 284 | 465 | 106 |
| 9 | 75 C. | 0 | 8.2 | 7.9 | 434 | | | | |
| 10 | 5 h | 10 | 10.2 | 9.4 | 752 | | | | |
| 11 | | 12.5 | 11 | 9.8 | 465 | | | | |
| 12 | | 15 | 12 | 10.8 | 278 | | | | |
| 13 | 75 C. | 0 | 8.2 | 7.7 | 619 | | 276 | 418 | 205 |
| 14 | 22 h | 10 | 10.2 | 9 | 800 | | 284 | 445 | 67 |
| 15 | | 12.5 | 11 | 9.3 | 356 | | 230 | 415 | 40 |
| 16 | | 15 | 12 | 10.2 | 239 | | 222 | 264 | 50 |

TABLE 8
Effect of Thermal (90 C./20 h)/Alkali treatment of 10% BS on CST
and Viscosity Untreated biosolids had a CST (at 3% BS) of 348

| | | | | | | CST 3% |
|---|---|---|---|---|---|---|
| | | | | | | After |
| | | | | | | Homog/ |
| | | | | | | Shear |
| | Ca(OH)2 | | | Viscosity | CST 3% | 10% for |
| | g/L | pH after | CST | 10% BS | After | 90 sec |
| Number | 10% BS | treatment | (Sec) | (cps) | 3 days | after 3 d |
| 1 | 12.5 | 9.4 | 1353 | 1752 | | |
| 2 | 15 | 9.6 | 633 | 1392 | | |
| 3 | 17.5 | 10.1 | 302 | 828 | | |
| 4 | 20.0 | 10.7 | 150 | 336 | 250 | 404 |

TABLE 9
Effect of pretreatment temperature, alkali dose and homogenization of 20% biosolids on viscosity, CST
value and centrifugation Untreated biosolids CST at 3% solids: 348

| | | Ca(OH)2 | | | | Centrifuged Cold 6000 g, | | | | Dilute 50:50, then Centrifuged | | | |
|---|---|---|---|---|---|---|---|---|---|---|---|---|---|
| | | g/L | | | | 15 min | | | | Cold 6000 g, 15 min | | | |
| Hold | | per | | | | Distribution | | Solids | | Distribution | | Solids | |
| Temp/ | Homogenized | 10% | Viscosity | Solids | CST | % | | Content % | | % | | Content % | |
| time | 60 sec | BS | 20% BS | Content % | 3% | Super | Pellet | Super | Pellet | Super | Pellet | Super | Pellet |
| 75 C. | No | 15 | 4919 | | | Not | | | | | | | |
| 22 hr | | | | | | Avail | | | | | | | |
| | | 20 | 3837 | 22.1 | 199 | 29.2 | 70.8 | 6.4 | 25.8 | 63.1 | 36.9 | 3.32 | 23.6 |
| 95 C. | No | 10 | 56900 | 20.4 | 525 | No | | | | | | | |
| 22 h | | | | | | sep | | | | | | | |
| | | 15 | 3671 | 21.7 | 400 | 30.5 | 69.5 | 6.9 | 26.1 | 68.5 | 31.5 | 2.75 | 31.8 |
| | | 20 | 1770 | 22.0 | 174 | 36.3 | 63.7 | 7.7 | 24.7 | 68.8 | 31.2 | 3.1 | 27.6 |
| 95 C. | Yes | 5 | 29200 | | | No | | | | | | | |
| 22 h | | | | | | sep | | | | | | | |
| | | 10 | 4973 | 20.3 | 925 | No | | | | | | | |
| | | | | | | sep | | | | | | | |

| 15 | 1116 | 21.0 | 490 | PoorerSep | 12.1 | 31.9 | A bit better | 3.3 | 28.4 |
|---|---|---|---|---|---|---|---|---|---|
| | | | | 43.0 | | | sep | | |
| | | | | 57.0 | | | 71.1 | | |
| | | | | | | | 28.9 | | |
| 20 | 714 | | | Not Avail | | | | | |

TABLE 10
Effect of thermal at 160 C. + Alkali treatment on dewatering

| | Ca(OH)2 | | Centrifuged Cold 6000 g, 15 min | | | |
|---|---|---|---|---|---|---|
| Hold | g/L per | Solids | Distribution % | | Solids Content % | |
| Temp/time | 10% BS | Content % | Super | Pellet | Super | Pellet |
| 160 C. | 0 | 24% | No separation | | | |
| 60 min | 20 | | 41 | 59 | 4% | 38% |

TABLE 11
Effect of temperature of thermal + alkali pretreated BS on centrifugation
effectiveness
Pre-Treat conditions: 20% solids. Untreated CST 3% 348

| | Ca(OH)2 | | | | Centrifuged 6000 g 15 min | | | | |
|---|---|---|---|---|---|---|---|---|---|
| Hold | g/L per | Viscosity | Solids | | | Distribution | | Solids | |
| Temp/ | 10% | 20% | Content | CST | | % | | Content % | |
| time | BS | BS | % | 3% | | Super | Pellet | Super | Pellet |
| 95 C. | 20 | 1770 | 22.0 | 174 | No | 36.7 | 63.3 | 7.7 | 31.2 |
| 22 h | | | | | Preheat | | | | |
| | | | | | *Preheat | 41.0 | 59.0 | 6.9 | 34.3 |

*Preheat: Metal casing + Tube + contents preheated 95 C./15 min

TABLE 12
Effect of pre-centrifuge treatment of thermal + alkali pretreated BS on dewatering effectiveness
Pre-Treat conditions: Prepared 22% TO Biosolids with 40 g Ca(OH)2 per Kg 20% Cake. Crock Potted
unmixed on low (98 C.) for 20 h. Replenished evaporated water. Final dry wt 22.80%.

| | | | | Pre-Centrifuge Treatment | | | | | |
|---|---|---|---|---|---|---|---|---|---|
| Hold | Ca(OH)2 | | Solids | | *Preheat | Centrifuged 6000 g 15 min | | | |
| Temp/ | g/L per | Viscosity | Content | Homogenize | 95 C./ | Distribution % | | Solids Content % | |
| time | 20% BS | 20% BS | % | 2 min | 15 min | Super | Pellet | Super | Pellet |
| 95 C. | 40 | 1362 | 22.8 | No | No | 39.75 | 60.25 | 6.8 | 34.7 |
| 22 h | | | | | | | | | |
| | | | | Yes | No | 29.10 | 70.90 | 7.4 | 29.1 |
| | | | | No | Yes | 41.13 | 58.87 | 6.6 | 36.5 |

TABLE 13
Effect of thermal treatment at 121 C. + Alkali treatment on dewatering

| Hold | Ca(OH)2 | Solids | Centrifuged Hot 6000 g 15 min | | | |
|---|---|---|---|---|---|---|
| Temp/ | g/L per | Content | Distribution % | | Solids Content % | |
| time | 10% BS | % | Super | Pellet | Super | Pellet |
| 121 C. | 0 | 24% | No separation | | | |
| 75 min | | | | | | |
| | 20 | | 39 | 61 | 3 | 37% |

TABLE 14
Characterization of pellet (cake) from thermal + alkali pretreated BS,
preheated to 95 C./15 min before centrifugation
Pre-Treat conditions: Prepared 22% Biosolids with 40 g Ca(OH)2 per Kg 20% Cake.
Crock Potted unmixed on low (98 C.) for 20 h. Replenished evaporated water. Final dry wt 22.80%.

| | | | | Centrifuged hot at 6000 g 15 min | | | | | | |
|---|---|---|---|---|---|---|---|---|---|---|
| | | | | | | | | | Fraction | |
| | | | | | Fraction | | Fraction | Solids | Volatile | Volatile |
| Hold | Ca(OH)2 | | Solids | | Volumetric | | Solids | Distrib | Solids | Solids |
| Temp/ | g/kg per | Viscosity | Content | | Distribution | | Content | -ution | Content | Distribution |
| time | 20% BS | 20% BS | % | Fraction | g | % | % | % | % | % |
| 95 C. | 40 | 1362 | 22.8 | Super | 21.74 | 44.1 | 7.5 | 13.6 | 76.7 | 20.0 |
| 22 h | | | | Pellet | 27.58 | 55.9 | 37.7 | 86.4 | 44.6 | 80.0 |
| | | | | Pellet | 12.80 | 26.0 | 28.8 | 30.7 | 54.5 | 31.9 |
| | | | | Top | | | | | | |
| | | | | Half | | | | | | |
| | | | | Pellet | 14.78 | 30.0 | 45.3 | 55.7 | 39.2 | 48.2 |
| | | | | Bottom | | | | | | |
| | | | | Half | | | | | | |

Preheat: Metal casing + Tube + contents 95 C./15 min

Accordingly, it will be understood that reasonable variations and modifications of the invention disclosed herein above are possible, whereby the specific illustrative examples set out herein are not to be construed as restrictive to the broad features of the present invention.

### LIST OF ELEMENTS

1 18% biosolids cake
2 alkali
3 mix/cooker
6 resulting material
7 severely sheared
8 no further watering
9 liquid
10 liquid fertilizer
21 biosolids cake
22 alkali, finely divided
23 mixed
24 heated and held
25 reactor
26 product moved to dewatering
27 separator-dewatering
28 solids-containing cake
29 liquid fraction
30 digester
31 dewatered BSC further processed

1. A process for improving de-waterability of a biosolids cake having an initial biosolids content greater than 10%, the process comprising the following steps:
(a) placing the biosolids cake in a reactor;
(b) raising and holding the pH of the biosolids cake to 11 or higher by intermixing the biosolids cake with a predetermined amount of an alkali to provide a modified biosolids cake in the reactor;
(c) raising and holding the temperature of the modified biosolids cake to at least 80 degrees Celsius for a predetermined time period to provide a treated biosolids cake in the reactor;
(d) testing the treated biosolids cake in a de-watering device wherein a liquid fraction of the treated biosolids cake is separated from a solids-containing fraction thereof; and
(e) wherein the biosolids cake is treated by a combination of steps (b) and (c) for a period of time sufficient for the solids-containing fraction to have a biosolids content thereof that is greater than the initial biosolids content.

2. (canceled)

3. A process as claimed in claim 1 wherein the biosolids content of the solids-containing fraction is more than 10% greater than the initial biosolids content.

4. A process as claimed in claim 3 further including preparing the liquid fraction to be fed back into waste digesters in the absence of the solids-containing fraction.

5. A process as claimed in claim 4 further including feeding the liquid fraction back in to the waste digesters.

6. A process as claimed in any of claim 1 wherein the solids-containing fraction is a solid.

7. A process as claimed in claim 1 wherein the solids-containing fraction is dried.

8. A process as claimed in claim 5 wherein the solids-containing fraction is dried for use as a fertilizer.

9. A process as claimed in claim 1 further comprising the following steps:
(f) rehydrating the solids-containing fraction by mixing the solids-containing fraction with a liquid to form a fertilizing liquid; and
(g) utilizing the fertilizing liquid as a fertilizer.

10. A process as claimed in claim 1 further excluding mechanical shearing of the biosolids cake prior to the testing in step (d).

11. A process as claimed in claim 1 further excluding mechanical shearing prior to separation of said liquid fraction from said solids-containing fraction in step (d).

12. A process as claimed in claim 7 wherein the solids-containing fraction is a solid fraction.

13. A process as claimed in claim 1 wherein the alkali is selected from the group consisting of CaO, CaOH, lime, and any combination thereof.

14. A process as claimed in claim 1 in which the predetermined amount of alkali added in step (b) is greater than one of 10 grams, 15 grams or 20 grams as calcium hydroxide Ca(OH)₂ per kilogram of the biosolids cake having 10% biosolids content.

15. A process as claimed in claim 1 in which an alkali other than calcium hydroxide is added in an amount equivalent to the predetermined amount of step (b) that is supplied as calcium hydroxide.

16. A process as claimed in claim 1 where the predetermined amount of the alkali added in step (b) is increased proportionately with increases in the biosolids contents in the biosolids cake.

17. A process as claimed in claim 1 in which the temperature and predetermined time period in step (c) are 80-99.9 degrees Celsius and 6-24 hours, respectively.

18. A process as claimed in claim 1 in which the temperature and predetermined time period in step (c) are 100-129 degrees Celsius and 1-3 hours, respectively.

19. A process as claimed in claim 1 in which the temperature and predetermined time period in step (c) are 130-170 degrees Celsius and 30-60 minutes, respectively.
